(19) United States
(12) Patent Application Publication
(10) Pub. No.: US 2019/0216110 A1
(43) Pub. Date: Jul. 18, 2019

(54) GELLED FEED FOR ANIMALS AND PROCESS FOR PREPARATION THEREOF

(71) Applicant: CAN TECHNOLOGIES, INC., Wayzata, MN (US)

(72) Inventor: Hervé GABILLET, Lanouee (FR)

(73) Assignee: CAN TECHNOLOGIES, INC., Wayzata, MN (US)

(21) Appl. No.: 16/335,380

(22) PCT Filed: Sep. 25, 2017
(86) PCT No.: PCT/US2017/053260

§ 371 Date: Mar. 21, 2019

(30) Foreign Application Priority Data
Sep. 23, 2016 (FR) 1658977

(51) Int. Cl. A23K 20/163; A23K 20/142; A23K 20/158; A23K 50/60; A23K 50/30

(52) U.S. Cl. CPC A23K 20/163; A23K 20/142; A23K 20/158; A23K 50/60; A23K 50/30; A23V 2300/31; A23V 2200/228; A23V 2250/506; A23V 2250/5086; A23V 2250/507; A23V 2300/24; A23V 2002/00

(57) ABSTRACT

The present invention relates to a process for preparing a gelled feed for piglets, said method comprising: a) forming a mixture of water and of a gelling agent, b) adding at least one nutritive element to said mixture, c) cooling the mixture until the mixture has gelled, d) destructuring the gelled mixture to obtain a gelled feed for piglets, wherein the gelling agent comprises from 50 to 75% by weight of xanthan gum, from 0.5 to 13% by weight of locust bean gum and from 12 to 37% by weight of guar gum, relative to the total weight of the gelling agent, and the temperature of the water is from 65 degrees Celsius to 85 degrees Celsius, for example 80 degrees Celsius. The present invention also relates to a gelled feed for piglets, obtained by the process defined according to the invention.

### CROSS-REFERENCE TO RELATED APPLICATIONS

This application claims the benefit of French Patent Application No. 1658977, filed Sep. 23, 2016, which is hereby incorporated by reference in its entirety.

### BACKGROUND

There are many situations in which it is needed to provide to an animal a supply of both feed and water. However, providing both can be difficult, impractical, and/or expensive. For example, when livestock are being transported it is difficult and expensive to maintain a supply of water for such livestock. In addition, there are situations in the life of an animal where the animal does not have much interest in consuming feed, but the animal nonetheless has particular nutritional needs. For example, the weaning stage of an animal can pose nutritional problems because the young animal needs to learn how to consume solid food. It is sometimes difficult for the young animal to get accustomed to nourishment other than by suckling. Early weaning provides advantages relating to avoidance of diseases and increased weight gain. However, care is needed when using early weaning to ensure that the young animal consumes sufficient nutrients.

Some animals such as sow require special nutritional needs just prior to and after farrowing. Proper nutrient intake is needed by the sow for the growth of developing fetuses, the sow's own body needs (body maintenance), for lactation, and for minimizing any feed intake depression by the sow after farrowing.

Growing and finishing pigs on occasion also have special nutrient requirements which may be due to any number of factors such as diseases and environmental factors. Diseases and environmental factors may affect nutritional intake which can in turn affect profitability for the swine farmer.

Improvements in swine genetics and swine raising techniques has improved sow prolificacy. However, this increase of the prolificacy means lighter piglets at birth and less milk per piglet (Ngo et al., Influence du rang de portée et du nombre de porcelets allaités sur la production laitière des truies, Journ. Rech. Porcine, 44, 195-196, 2012), and as a consequence, an increase of the perinatal mortality. The single biggest factor related to preweaning mortality in farrowing pens is weakness and poor viability. Accordingly, early piglet nutrition appears to be a key factor in piglet survival.

De Rodas (36th Annual Meeting AASV, March 2005, Toronto, Calif., p. 125-128) disclosed a summary of trials evaluating the effect of feeding a gel-based feed during the first seven days after weaning on performance of nursery pigs. The gel feed provides the young pig with both a feed and a water component. The gel contains high quality ingredients, is highly palatable and is shelf stable at room temperature.

### SUMMARY OF THE INVENTION

Described herein are processes for producing a gelled feed for animals, the feeds produced from such processes, and methods for feeding animals with such feeds. In one aspect, the process is a process for preparing a gelled feed for an animal, comprising: a) forming a mixture of water and a gelling agent, wherein the temperature of the water is from 60° C. to 85° C., b) adding one or more nutritive elements to the mixture, c) cooling the mixture until it has gelled, and d) destructuring the gelled mixture to obtain a gelled feed, wherein the gelling agent comprises from 50 to 75% by weight of xanthan gum, from 0.5 to 13% by weight of locust bean gum, and from 12 to 37% by weight of guar gum, relative to the total weight of the gelling agent.

In some embodiments, the water in step (a) is warm or hot water. In some embodiments, the step of forming the mixture of water and the gelling agent is carried out at a temperature of about 60° C. to about 70° C. In some embodiments, the step of forming the mixture of water and the gelling agent is carried out at a temperature of about 65° C. to about 85° C. In some embodiments, the step of forming the mixture of water and the gelling agent is carried out at a temperature of about 80° C. In some embodiments, the mixing in step a) is carried out under high shear.

Nutritive elements, e.g., feed materials and/or medicines, are then added to the mixture. In some embodiments, step b) is carried out while mixing at a temperature of from 60° C. to 70° C. After the nutritive elements are added, the mixture is cooled to form a gelled mixture. In some embodiments, the cooling is carried out until the mixture reaches a temperature of less than or equal to about 20° C.

In one aspect, this disclosure relates to a gelled feed composition for an animal. In some embodiments, the gelled feed is a feed formed by any embodiments of the process described above and elsewhere herein. In some embodiments, the gelled feed comprises from 0.1 to 2% by weight of gelling agent relative to the weight of the gelled feed. In some embodiments, the gelled feed is an unstructured gelled feed.

In one aspect, this disclosure also relates to a gelling agent useful for producing gelled animal feeds. In some embodiments, the gelling agent comprises from 50 to 75% by weight of xanthan gum, from 0.5 to 13% by weight of locust bean gum and from 12 to 37% by weight of guar gum, relative to the total weight of the gelling agent. In some embodiments, the gelling agent consists of from 50 to 75% by weight of xanthan gum, from 0.5 to 13% by weight of locust bean gum and from 12 to 37% by weight of guar gum, relative to the total weight of the gelling agent. In some embodiments, the gelled feed or gelling agent is substantially free of pectin.

In one aspect, this disclosure relates to a method for feeding an animal, comprising providing to an animal any embodiment of a gelled feed described herein, or a gelled feed formed according to any embodiment of the processes described herein. In some embodiments, the animal is swine. In some embodiments, the gelled feed is provided to the animal within about the first ten days after the animal's birth.

It is also to be understood that the elements or aspects of any embodiment of the processes, methods, or compositions described above can be applied to any other embodiment, as would be understood by a person skilled in the art.

### DETAILED DESCRIPTION

It is to be understood that the figures and descriptions of the present invention provided herein have been simplified to illustrate elements that are relevant for a clear understanding of the present invention, while eliminating other elements found in the related field(s) of art. Those of ordinary skill in the art would recognize that other elements or steps may be desirable or required in implementing the present invention. However, because such elements or steps are well known in the art or do not facilitate a better understanding of the present invention, a discussion of such elements or steps is not provided herein.

Throughout this disclosure, various aspects of the invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 7 should be considered to have specifically disclosed subranges such as from 1 to 3, from 1 to 4, from 1 to 6, from 2 to 5, from 3 to 5, etc., as well as individual numbers within that range, for example, 1, 2, 3, 3.6, 4, 5, 5.8, 6, 7, and any whole and partial increments in between. This applies regardless of the breadth of the range.

### Definitions

Unless defined otherwise, all technical and scientific terms used herein have the same meaning as commonly understood by one skilled in the art to which this invention belongs. As used herein, each of the following terms has the meaning associated with it as defined in this section.

The terms “gel,” “hydrogel,” and the like refer to a mixture of a gelling agent and water which has formed a solid or partially solid jelly-like material.

The terms “gel feed,” “gelled feed,” “gel feed composition,” and “gelled feed composition,” are used interchangeably herein and refer to a combination of a gel and one or more nutritive elements. Unless stated or implied otherwise, any use of the terms “animal feed,” “feed” or “feed composition” refer to the gel feed of the present invention.

The terms “nutrient,” “nutritive elements,” “nutritional additives,” and the like refer to any composition or material which enable the growth of an animal, promote the health of an animal, and/or are necessary for an animal's survival. In some embodiments, a nutrient can include any material that is desired to be provided to an animal via feed, including such materials as medications.

The term “unstructured” as used herein with respect to a gel feed, refers to a composition which does not have a well-defined, homogenous structure. As would be understood by a person skilled in the art, an unstructured feed can be amorphous or non-crystalline. A gel feed produced in an unstructured form can exhibit properties such as increased flowability (i.e., having a “light or thin consistency”) and reduced stickiness or tackiness.

### Method of Preparing an Animal Feed and Feed Compositions Resulting Therefrom

Described herein are methods for preparing animal feeds and the feed compositions produced from such methods. In one aspect, the feed compositions are gel feeds. In some embodiments, the gel feeds are useful for feeding swine. In some embodiments, the feed is useful for piglets within the first ten days of life. A description of the use of gel feeds for swine is provided in WO 2016/135623, published Sep. 1, 2016, which is hereby incorporated by reference in its entirety. The gel feeds described herein include different gelling agent compositions than those described in WO 2016/135623, and provide decreased stickiness and improved flowability compared to other gel feeds. The decreased stickiness and improved flowability of the feeds provides for easier intake of the feed by animals, easier administration of the feed to the animal, and also improves the cleanliness of the animal and/or animal pen. In some embodiments, the gel feeds are substantially free of pectin, i.e., no pectin would be detected by a standard analytical method known in the art.

In one aspect, the gel feed does not stick or adhere to the skin of the animal being fed. Further, the gel feed exhibits little or no syneresis, i.e., the liquid contained in the gel feed will not separate from the solids. One benefit of the gel feed is that it does not contain any alginate or carrageenan, which are texturants that are forbidden for use in feed by regulations in some countries.

In one aspect, the gelling agent of the gel feed is made from a combination of xanthan gum, locust bean gum, and guar gum. It has been surprisingly found that the combination of these three texturants exhibit a synergistic effect. This combination creates a firm and strong gel, whereas using just xanthan gum and locust bean gum forms an elastic gel in the presence of salts, and using just xanthan gum and guar gum creates a soft gel. In some embodiments, no other texturants are used other than xanthan gum, locust bean gum, and guar gum.

Guar gum comes from the legume Cyamopsis tetragonolobus, and has viscosifying properties and water retention. In one aspect, guar gum approximates the properties of fiber. Locust bean gum is derived from carob seeds originating from the carob tree. In one aspect, locust bean gum can serve as a thickener. Xanthan gum is a polysaccharide obtained from the action of a bacterium, Xanthomonas campestris. In one aspect, its main characteristic is to considerably increase the viscosity of an aqueous medium. To obtain a high viscosity, the temperature of the medium as a function of the salt content and the applied shear force are important parameters to be taken into account when making the gel feed described herein.

In one aspect, the gelling agent includes from 50 to 75% by weight of xanthan gum, from 0.5 to 13% by weight of locust bean gum and from 12 to 37% by weight of guar gum, relative to the total weight of the gelling agent. In some embodiments, the gelling agent includes from 55 to 75% xanthan gum, 60 to 75% xanthan gum, 65 to 75% xanthan gum, 55 to 70% xanthan gum, 55 to 65% xanthan gum, or 55 to 60% xanthan gum. In some embodiments, the gelling agent includes 0.5 to 10%, 0.5 to 5%, 0.5 to 2%, 1 to 10%, 1 to 5%, 2 to 5%, or 5 to 10% locust bean gum. In some embodiments, the gelling agent includes 12 to 30%, 12 to 20%, 15 to 30%, 20 to 30%, 25 to 30%, or 12 to 15% guar gum. In one aspect, the gelling agent consists of xanthan gum, locust bean gum, and guar gum in any combination of the ranges identified in this paragraph, as would be understood by a person skilled in the art.

In one aspect, the gel feed is free of pectin. The combination of xanthan gum, locust bean gum, and guar gum can provide a less expensive gelling agent than a pectin-based gelling agent. Further, this combination of three texturants can provide a gelling agent with improved properties over pectin-based gelling agents.

Throughout this disclosure, the gel feeds are typically described for use in feeding swine. However, the feeds described herein are not limited for use with swine, and can be used for other animals, including other types of livestock and pets. In one aspect, feeds prepared by the methods described herein are useful for providing a complete feed for an animal, i.e., the feed provides both the nutritional and water requirements for the animal.

In one aspect, the gel feeds are unstructured, and therefore have a light consistency that also is less prone to sticking than other types of feeds. The light or thin consistency of the unstructured gel feed enables easier intake by piglets compared to other types of feed. Further, in one aspect, the feeds have excellent palatability for piglets. Further still, the unstructured gel feed has excellent stability. In some embodiments, the feed can be stable for up to 2 years or more, which makes the feed particularly useful for breeders, who may need to store quantities of feed for significant periods of time. In one aspect, the unstructured gel feed is sufficiently soft to be consumed easily by piglets or other young animals. For example, in some embodiments, the gel feed can have a viscosity and consistency similar to a typical porridge.

In one aspect, the process or method for preparing an animal feed includes the steps of: a) forming a mixture of water and a gelling agent; b) adding one or more nutritive elements to the mixture; c) cooling the mixture until it has gelled; and d) destructuring the gelled mixture to obtain a gelled feed. In some embodiments, the gelling agent comprises from 50 to 75% by weight of xanthan gum, from 0.5 to 13% by weight of locust bean gum, and from 12 to 37% by weight of guar gum, relative to the total weight of the gelling agent. In some embodiments, the gelling agent consists of from 50 to 75% by weight of xanthan gum, from 0.5 to 13% by weight of locust bean gum, and from 12 to 37% by weight of guar gum, relative to the total weight of the gelling agent.

In some embodiments, the water in step (a) has a temperature suitable for obtaining a mixture of a gelling agent in water. In some embodiments, the mixture is substantially homogenous prior to starting step (b). In some embodiments, the temperature of the water in step (a) is about 60° C. to about 85° C., 65° C. to about 85° C., or about 70° C. to about 80° C. In some embodiments, the water is about 65° C. In some embodiments, the water is about 80° C. In some embodiments, the water in step (a) can be less than 60° C., provided that the temperature of the water is suitable for mixing the gelling agent with the water.

As described above, in some embodiments, the gelling agent includes a mixture of xanthan gum, locust bean gum (LBG), and guar gum. In some embodiments, the gelling agent can include other materials. In some embodiments, the gelling agent can include only xanthan gum, only LBG, or only guar gum. In some embodiments, the gelling agent can include a combination of any two of xanthan gum, LGB, and guar gum. In some embodiments, the gelling agent is substantially free of pectin. “Substantially free of pectin” means that no pectin can be detected in the gelling agent, or the amount of pectin in the gelling agent is so low that it does not have a measurable effect on the properties of the gelling agent. The presence of pectin in the gelling agent can reduce the flowability (i.e., increase the consistency) and/or increase the stickiness of the final gel feed produced.

The gelling agent composition used in the present invention can allow binding with water and/or is capable of forming a matrix in which the feed nutrient is retained. In some embodiments, the total amount of gelling agent may be in a concentration of from about 0.5 to 3.0% by weight of the total weight of the unstructured gel feed, of from about 1.0% to 2.8%, of from about 1.3% to 2.7%, of from about 1.5% to 2.5%, of from about 1.7 to 2.3, or of about 2.0%. In some embodiments, the gelling agent is present in a concentration of from about 0.5% to 2.3% by weight of the total weight of the unstructured gel feed, for example of from about 1.0 to 2.0, or of about 1.7% of the total weight of the unstructured gel feed.

In one aspect, the unstructured gel feed provides piglets with both a feed component and a water component. In some embodiments, the gel feed includes an amount of water to an extent that no additional water external of the feed is needed for the piglets' sustenance. For example, in some embodiments, dry matter in the unstructured gel may be less than 45% weight percent of the total weight of the unstructured gel, for example 25 to 45%, or from 30-35%.

Nutritive elements are added to the mixture in step (b). Nutrients useful for the gel feed can include proteins, carbohydrates, fats, fibers, and vitamins Non-limiting examples of nutrients include: Lysamine, Maltodextrin, Lactose, Hylise, Seleniomethionine-alkosel, Manno-oligosaccharides and b-glucans, Yeast extracts, Agrimos, Potassium butyrate, Aroma vanilla (vanilla flavoring), Potassium sorbate, Dextrose, Vitamin C, Monopropylene glycol, Glycerin, Medium chain triglycerides, Radiamuls, Soybean oil, Choline chloride, Butylated hydroxytoluene, green tea extract, WPC35 concentrated serum proteins, hydrolysed, wheat gluten, core vitamins, Lysine, Methionine, L-threonine, Tryptophan, algal Docosahexaenoic acid (DHA), and Vitamin E50.

In some embodiments, the gel feed can also include one or more organic acids. Non-limiting examples of organic acids include Trisodium citrate, Citric acid, and Fumaric acid.

Suitable sources for protein useful in the composition of the present invention include both animal and plant based protein. Non-limiting examples of plant based protein include whey protein concentrate, wheat flour, pea protein, patata protein, fermented patata protein, soya protein concentrate, alfalfa meal, canola seed meal, rice protein, coconut meal (copra), wheat gluten, cotton seed meal, linseed meal (flax), peanut meal, safflower meal, sesame meal, soybean meal, soybean proteins and sunflower meal and other oil seed meals.

Non-limiting examples of carbohydrates useful in the present invention include sorgum flour, ground rice, rice flour, ground corn, oat products, wheat, ground sorgum, or starch from any suitable grain such as wheat, oats, barley, and triticale, or tubers such as tapioca, and patata. Lactose, dextrin, sucrase, fructose and other simple sugars are also suitable carbohydrates.

Non-limiting examples of fats useful in the present invention may come from both plant or animal sources. Some fat may be the result of inclusion in the protein or carbohydrate source. However, additional fat may be added and is typically a rendered product such as a blended fat (animal and vegetable blends), or may be a poultry fat or tallow or a vegetable source such as soybean oil, corn oil, canola oil, coconut oil, olive oil, palm oil, copra oil and the like. Fat is necessary as a source of energy, and also is necessary in the assimilation of certain vitamins that may be added to the feed of the present invention.

Fiber useful in the present invention is dietary fiber. Non-limiting examples of sources of dietary fiber are the same plant sources that provide protein and/or carbohydrates. If additional dietary fiber is needed, it may be obtained from such typical sources as soybean hulls or psyllium.

In addition to the nutrients discussed above, it may be desirable to provide additional supplementation of vitamins and minerals depending on the needs of the particular animal.

In step (c), the mixture is cooled until it is gelled. In some embodiments, the mixture is cooled to a temperature of less than or equal to 20° C. In some embodiments, the mixture is cooled to a temperature of less than or equal to 15° C. In some embodiments, the mixture is cooled to a temperature of less than or equal to 25° C.

In step (d), the gelled mixture is destructured. For the purposes of this disclosure, “destructuring” is intended to mean any action making it possible to make the gelled mixture obtained in step c) of the process of the invention sufficiently soft for it to be able to be consumed by a young animal, for example piglets less than 11 days old. In some embodiments, the destructuring can be carried out by a chopper, a stirrer, an impeller, and the like. However, the method of destructuring is not limited to any specific method described herein and can include any method for changing the structure of the gelled mixture to make the mixture more thin, soft, and/or flowable.

In some embodiments, the gel feed of the present invention may be used as a delivery system for medication such as antibiotics and chemotherapeutics or for microbial supplements such as probiotics and nutraceuticals. In some embodiments, the medication can be the sole constituent in the gel feed aside from the gel, i.e., the medication is included in the gel feed instead of nutritive elements. In some embodiments, the medication can be included with one or more of the nutrients described elsewhere herein. Examples of antibiotics approved for swine or other livestock include apramycin, bacitracin methylene disacylate, bacitracic zinc, bambermycins, chlortetracycline, lincomycin, neomycin, oxytetracycline, penicillin, tiamulin, tylosin, and virginiamycin. Chemotherapeutics approved for swine include arsanilic acid, carbodox, roxarsone, sulfamethazine and sulfathiazole.

The gelled feed produced by the methods described herein can have the following advantages compared to other feeds currently used:

| Property of gelled feed | Advantage provided |
|---|---|
| destructured gel | feed easily taken up by an animal |
| non-tacky gel | avoids waste |
| controlled syneresis | more homogeneous product presentation |
| controlled gel strength | more homogeneous product presentation |
| | and easily taken up |
| product stability quality | shelf life = 2 years or greater |
| (microbio, pH, ingredients) | |

### Method of Feeding an Animal

In one aspect, the present invention also includes a method of feeding an animal with the unstructured gel made according to the method of the invention. All the definitions and embodiments described above in relation with the method for manufacturing a feed for piglets in the form of gel are also suitable for this aspect of the invention.

In one aspect, the animal is fed the unstructured gel feed on any day from day 1 to day 10 after birth. Feeding within this time is particularly useful for assisting in particular weak or supernumerary animals in a group of newborns. The gel feed can also be provided in case of digestive disturbance for stabilization of water and electrolyte balance. In some embodiments, the gelled feed can be administered to an animal from day 11 after birth.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather should be construed to encompass any and all variations which become evident as a result of the teaching provided herein.

### Example 1

### Method of Making a Gel Feed For Piglets

This example provides an embodiment for making a gel feed, in which the gelling agent is a combination of xanthan gum, guar gum, and locust bean gum. Cycle time/batch: 2 H

| Phases | | Instructions | Designation steps |
|---|---|---|---|
| 1. | Loading water | Water meter: 400 liters | Loading of 400 liters of hot water |
| | | | End loading 400 liters hot water |
| 2. | Loading of the | Vacuum pump to start | Starting vacuum to suction of the liquid |
| | liquid core | | core: vacuum setpoint: −0.5 b |
| | | Vacuum: −0.5 b | Suction of the liquid core and rinsing piping |
| | | | with 2 liters of water. |
| | | | Stop vacuum and returned to atmosphere of |
| | | | the mixture |
| 3. | Gelling agent | Paddle stirrer in running: | Starting paddle stirrer |
| | base | speed 26 Hz | |
| | manufacturing | | Loading gelling agent powder by the |
| | | | vacuum bags hopper |
| | | | End loading gelling agent powder |
| | | Dispersers in running | Starting dispersers |
| | | Water meter: 70 liters | Adding 70 liters of hot water by the vacuum |
| | | | bags hopper: rinsing powder on the shaft of |
| | | | the paddle stirrer |
| | | Vacuum: −0.5 b - time of | Start mixing gelling agent base - time of |
| | | mixture: 10 min | mixture setpoint: 10 min |
| | | After 10 min of mixture | Stop mixing, stop vacuum and returned to |
| | | under vacuum | atmosphere of the mixture |
| | | Temperature control of | State value of temperature of the gelling |
| | | mixture | agent mixture: setpoint: |
| | | | 10° C. < 70° C. < T° C. < 80° C. |
| 4. | Cooling gelling | Cold water circulation jacket | Cold water circulation jacket to reduce |
| | agent base | | temrperature of the gelling agent base |
| | | Paddle stirrer running: speed | Starting paddle stirrer |
| | | 26 Hz | |
| | | After 20 min of cooling, | State value of temperature of the gelling |
| | | control temperature of the | agent mixture: setpoint: |
| | | mixture | 10° C. < 10° C. < T° C. < 17° C. |
| 5. | Loading powders | Paddle stirrer in running: | Starting paddle stirrer |
| | core | speed 26 Hz | |
| | | | Loading powders by vacuum bags hopper |
| | | | End loading powders, closure valve of |
| | | | vacuum bags hoper |
| | | Speed paddle stirrer: 50 Hz | Increasing speed of paddle stirrer, starting |
| | | Dispersers in running | dispersers and mixture during 10 min |
| | | Mixing time: 10 min | |
| | | After 10 min of mixing | Stop agitations |
| | | Temperature control of | State value of mixture temperature: setpoint: |
| | | mixture | 10° C. < T° C. < 17° C. |
| 6. | Preparation of | Water meter: 40 liters | Loading 40 liters of cold water in the stirred |
| | acids core | | tank of 60 liters |
| | | | End loading 40 liters cold water |
| | | | Loading liquid acids in the stirred tank of 60 |
| | | | liters |
| | | | End loading liquid acids |
| | | Pneumatic agitator in | Starting pneumatic agitator on tank of 60 |
| | | running - speed: valve ⅓ | liters and adjusting stirring speed |
| | | | Loading powder acids under agitation |
| | | | End loading of powder acids, closure and |
| | | | clamping the lid of the stirred tank |
| | | Speed pneumatic agitator - | Increasing speed of agitation in the tank of |
| | | speed: valve opened to the | 60 liters, time of mixing: 2 min minimum, |
| | | maximum | the time to carry out adjustments on the |
| | | | control cabinet |
| 7. | Adjustment of | Switch of dispersers in “off” | Switch of the switch of dispersers on “off” |
| | parameters to | position | position in front of the control cabinet |
| | include acids core | Mixer clock set at 30 s | Adjust the operation time clock of the paddle |
| | | | stirrer on 30 s |
| | | Potentiometer speed of the | Adjust the potentiometer speed of the paddle |
| | | paddle stirrer set at 10 | stirrer on 10 |
| 8. | Incorporation of | Paddle stirrer in running: | Starting the paddle stirrer |
| | the acids core | speed 50 Hz | |
| | | Opening the drain valve of | Incorporation under agitation of the acids |
| | | the stirred tank of 60 liters, | solution by quick opening of the dran valve |
| | | time of mixture 30 seconds | of the stirred tank of 60 liters |
| | | | End incorporation acids solution, stop |
| | | | pneumatic agitator and closure of the drain |
| | | | valve |
| | | After 30 seconds of mixing | Stop the paddle stirrer and beginning of the |
| | | at 50 Hz | gelation in static |
| | | Temperature control of the | State value of the mixture temperature: |
| | | mixture | setpoint: 10° C. < T° C. < 17° C. |
| 9. | Gelation | Time of gelation: 50 min | Time of gelation of the mixture in static: 50 |
| | | | min. Note the start time of gelation |
| 10. | Adjustment of | Clock of mixer set at 120 s | Adjust the operation time clock of the paddle |
| | parameters for | | stirrer on 120 s |
| | disintegration of | Potentiometer speed of the | Adjust potentiometer speed of the paddle |
| | gel | paddle stirrer set between 1 | stirrer between 1 and 2 |
| | | and 2 | |
| | | Switch of dispersers in “off” | Make sure that the switch of the dispersers is |
| | | position | in “off” position |
| 11. | Disintegration of | Paddle stirrer running: speed | Beginning paddle stirrer |
| | the gel | 13 Hz | |
| | | Mixture time: 4 min | |
| | | After 4 min of disintegration | Stop paddle stirrer, end of disintegration |
| 12. | Degassing | Sop air bearings | Close the air flow control knobs on the |
| | unstructured gel | | bearings of the paddle stirrer and on the |
| | | | bearings od dispensers |
| | | Vacuum pump to start | Starting vacuum for degassing unstructured |
| | | | gel: vacuum setpoint: −0.4 b |
| | | Vacuum: −0.4 b - degassing | Beginning of degassing of the unstructured |
| | | time: 3 min | gel - setpoint of degassing time: 3 min at −0.4 b |
| | | After 3 min of degassing | Stop vacuum and gently return the tank to |
| | | at −0.4 b | atmosphere |
| | | Temperature control of the | State value of the mixture temperature: |
| | | mixture | setpoint: 10° C. < T° C. < 17° C. |
| 13. | Drain to the | Open drain valve under | Switch the valve switch in “on” position at |
| | production lines | mixer tank | the front of the control cabinet |
| | | Product quality control | Take a sample of the unstructured gel for |
| | | | quality control |
| 14. | Homogenizing of | Opening air bearing | Open and adjust the air flow control knobs |
| | the unstructured | | on the bearings of the paddle stirrer and on |
| | gel: to make | | the bearings of dispersers |
| | when remains | Clock of the mixer set at 60 | Adjust the operation time clock of the paddle |
| | about ¼ of | seconds | stirrer on 60 s |
| | product in the | Switch of dispersers in “off” | Make sure that the switch of dispersers is in |
| | mixer and end of | position | “off” position |
| | draining | Paddle stirrer running: Speed | Starting paddle stirrer |
| | | 13 Hz | |

### Example 2

### Gel Feed For Piglets Made by the Method of Example 1, and Study of the Feed in Piglets

EARLYSTART: complete feed in the form of gel for the first 10 days of life. An innovative and comprehensive solution for feeding piglets from day 1 to day 10

### Product

Direction for use Before opening, mix in the pouch during few seconds, then open the cap and fill the tray from Day 1 to Day 10. Every day, adapt the dosage to the daily intake, once or twice daily. On the first days of life, the intake will be approx. 100 gr i.e half a tray per day and per litter. It will increase day after day for reaching one complete tray (i.e 200 g) per day and per litter.

Composition Hydrolyzed wheat protein, Whey protein, Pea protein, Lactose, Dextrose, Glycerine, Caprylic and capric triglycerides, Soya oil, Maltodextrin, Yeasts and part thereof Propylene glycol, Salts of butyric acid.

Analytical constituents Dry matter: 32.10%, Crude protein: 9.10%, Crude oils and fats: 4.20%, Crude ash: 1.90, Crude fibre: 0.10%, Lysine: 0,50%, Methionine: 0.25% , Threonine: 0.35% , Tryptophan: 0.10% , Calcium: 0.10%, Phosphorus: 0.10%, Sodium: 0.20%.

Additives Nutritional additives⋅Vitamins: 3a672a Vitamin A: 16000 UI/Kg, E671 Vitamin D3: 2000 UI/Kg, 3a700 Vitamin E: 160 mg/Kg, Vitamin C: 350 mg/Kg⋅Trace elements: 3b8.11 Selenomethionine produced by Saccharomyces cerevisiaie NCYC R397: 0.25 mg/K Technological additives⋅Preservatives: E202 Potassium sorbate, E331 Trisodium Citrate, E330 Citric acid, 1a297 Fumaric acid⋅Antioxidant: E321 Butylated hydroxytoluene: 0.01%. Sensory additives Mixture of flavouring compounds

Gelling agent: xanthan gum, locust bean gum, guar gum, water.

Shelf life 2 years in original packing⋅store at ambient temperature and out of direct sunlight.

Packaging Eco-friendly Pouch 5 Kg (25 doses of 200 g)

### Study

The study was carried out on 427 piglets from 35 sows (LW LR Pietrain) randomly assigned to 2 batches only differing by diet:

a first batch CONTROL (18 sows, 213 piglets having an average
Weight at day 0 of 1.248 g and of which 46.009% were female) only receiving mother's milk from day 0 to day 10 then lactation (no food is distributed to the piglets or conventional livestock feed).
a second batch EARLYSTART (17 sows, 214 piglets having an average weight at day 0 of 1.31 g and of which 52.336% were female) receiving mother's milk and the complete feed EarlyStart (200 g per day and litter in a little preconditioned tray) from day 0 to day 10 then lactation (no food is distributed to the piglets or conventional livestock feed). The average consumption of the complete feed EarlyStart was 10 g/piglet/day during 10 days, then about 1143 g per litter. The consumption may be low on the first days. Then consumption may increase up to 3 times the initial consumption.

Sows were matched according to the rank and the litter size. The 35 sows selected for this study were randomly assigned to one of the two batches.

Piglets were weighed individually at days 0, 11 and 21. For the batch EarlyStart, the amount of complete feed EarlyStart ingested was measured daily for each litter from day 0 to day 10. The monitoring of mortality was conducted throughout the duration of the study with recording of dead animals.

The main criteria of the study were:

daily weight gain (DWG) at weaning. A calculation of the average daily gain was done for each litter, to compare the two batches.
homogeneity of litters.

The secondary criteria were:

daily weight gain (DWG) from day 0 to day 11. A calculation of the average daily gain was done from day 0 to day 11 for each litter, to compare the two batches.
mortality between farrowing and weaning.
relationship between growth and feed intake.

The experimental unit is the litter (DWG, feed intake) and the piglet (mortality). Regarding statistical tests, DWG was subjected to analysis of variance (ANOVA) to 1 factor (group) for the comparison of the two batches with the sow as a factor nestled in the group with the number of piglets of the litter as an adjustment variable. The homogeneity of litters was tested by calculating the standard deviation of each litter as a variable. Mortality was compared between batches using a Pearson's chi-square test.

### Properties

A decrease of the mortality before weaning (7,5% vs 14,60%=−48%, compared to piglets only receiving mother's milk).
An increase of the average daily gain (ADG) at day 11 of +14% and from birth until weaning of +20%, compared to piglets only receiving mother's milk).
A significant return on investment based only on the effect of the complete feed EarlyStart (without taking into account the 20% improvement of ADG).

### Example 3

### Composition of a Gelled Feed For Piglets

This composition represents an exemplary embodiment of a gelled feed produced by the methods described herein.

| Name | Amount in the feed (%) |
|---|---|
| LYSAMINE | 2 to 8% |
| MALTODEXTRIN | 1 to 5% |
| LACTOSE | 1 to 5% |
| MONOPROPYLENE GLYCOL | 0.5 to 5% |
| GLYCERIN | 1 to 5% |
| MEDIUM CHAIN TRIGLYCERIDES | 1 to 5% |
| RADIAMULS | |
| SOYBEAN OIL | 1 to 5% |
| CHOLINE CHLORIDE | 0.01 to 0.10% |
| BUTYLATED HYDROXYTOLUENE | 0.001 to 0.020% |
| GREEN TEA EXTRACT | 0.001 to 0.050% |
| WPC35 CONCENTRATED SERUM | 1 to 10% |
| PROTEINS | |
| HYDROLYSED WHEAT GLUTEN | 1 to 10% |
| VITAMIN CORE | 0.01 to 0.05% |
| LYSINE | 0.1 to 0.7% |
| METHIONINE | 0.1 to 0.7% |
| L-THREONINE | 0.1 to 0.7% |
| TRYPTOPHAN | 0.01 to 0.10% |
| ALGAL DHA | 0.001 to 0.020% |
| HYLISE | 0.5 to 5% |
| SELENOMETHIONINE - ALKOSEL | 0.001 to 0.050% |
| VITAMIN E50 | 0.001 to 0.050% |
| VITAMIN C | 0.001 to 0.050% |
| MANNOOLIGOSACCHARIDES and B- | 0.01 to 0.10% |
| GLUCANS EXTRACTED from YEASTS - | |
| AGRIMOS | |
| POTASSIUM BUTYRATE | 0.1 to 0.7% |
| VANILLA FLAVOURING | 0.1 to 0.7% |
| POTASSIUM SORBATE | 1 to 5% |
| TRISODIUM CITRATE | 0.2 to 1.5% |
| CITRIC ACID | 0.2 to 1.5% |
| FUMARIC ACID | 0.5 to 5% |
| GELLING AGENT | 0.1 to 2% |
| HOT WATER | 50 to 80% |
| DEXTROSE | 1 to 7% |
| | Composition, in %, in |
| Gelling agent | the gelling agent |
| Xanthan gum | 50 to 75% |
| Guar gum | 12 to 37% |
| Locust bean gum | 0.5 to 13% |

In some embodiments, the gel feed has the following physical chemical specifications.

Aspect: Creamy white powder;
Particle size: 95% through 150 μm-u.s. Stand. NO100;
pH (1% gel): 5.0-8.0;
Loss on drying: Max 15%

### Example 4

### Evaluation of the Zootechnic Efficiency of a Feeding Gel For Young Piglets, Earlystart, Distributed Between 0 and 10 Days

The study is a controlled and randomized comparative test realized in two contemporary groups among which the one will receive an exemplary embodiment of the gel feed described herein (EARLYSTART™). Sows will be matched according to the rank and litter size. The litter of both two groups will be evaluated on zootechnical performances.

The study is performed in farms, selected on the following criteria: Pig farms with a high prolificacy i.e., more than 13 piglets born alive per sow and per litter. Pig farms with a mortality rate before weaning which is >to 9%. The highest will be this mortality rate, the most important will be the effect of EARLYSTART. Practical possibility to set up the experiment with some farms which are including at least (in some contemporary trials) 15 litters for the control group and 15 litters for the trial group. Serious and cooperative breeder.

All piglets healthy and born at the peak of farrowing are included in the study.

Non-inclusion criteria: piglets sick or unviable not included.

Exclusion criteria: Generally, no exclusion is allowed during the study. Inclusion of animals in one of the two groups will be made following a random list. Randomization will be performed according to the size, rank and final weight of the litter after initial weighing.

For piglets from the first group (also called the “Control group”) no supplementation are distributed. However, for those of the second group (also called “Trial group”), EARLYSTART is distributed in addition. EARLYSTART is given ad libitum to piglets in a small red tray. In no case, another feed or additive (such as peat, litter dryer, milk replacer etc . . . ) is distributed to the animals during the study.

The daily quantity is increased day after day according to the intake of each litter which could be different with a ratio from 1 to 3, which is normal since this intake is bound to milk production of each sow. More the sow has an important milk production less the piglets will ingest gel, and vice versa.

Gel feed is used as soon as possible after piglets' birth. When first use is postponed, a negative impact can result on the intake for the whole period of 10 days. So even if the intake is weak, the piglets are acclimated and accustomed for the next days and the intake will increase.

### From D1 to D3, A Daily Intake of 50 g to 100 g/Litter

On the first 2-3 days of life, the intake is not so important as each litter will eat approximately 50 to 100 g/day. So the intake is quite low but this is 100% normal as the piglets don't have proper eating behavior on the first days of life and they are in a learning phase how to feed, mainly based on breast feeding. The exact location of the feed tray can also be very important. If putting the tray at the back of the farrowing pen, the intake can be at least 30% inferior compared to a location close to the head of the sow. The tray should be located close to sow's head and nest.

The parameters evaluated are mainly zootechnical. Piglet growth is assessed on the basis of two sets of individual weighing, a first at farrowing during inclusion and the second at weaning. The litters homogeneity and mortalities are also recorded. For both two batches followed, D0 is the day of birth of piglets included in the study.

At D0 (day 0):—Individual weighing and identification (ear tag) of piglets.—Distribution in groups of piglets and sows, taking into accounts the rank and litter size.—Distribution of the gel to the piglets of treated group.

Between D2 and D3:—Control of piglets care and adoptions which are inside a same group.—Equalization (by removing piglets assigned to a nurse sow) of the litter size average between two groups.—Follow up of animals and control of the study progress.

At D10:—End of the daily distribution of the gel.

Towards D28:—Weaning.—Individual weighing of the piglets. To analyze the effects on piglets, the statistical unit is the piglet. The effect of batch of sows is taken into account in the analysis of quantitative criteria (adjustments).

### Outcome Measures

Data is studied on following main criteria of statistical point of view:

Average daily weight gain (ADWG) at weaning
Litter homogeneity
Mortality between farrowing and weaning

The following parameters can also be recorded:

Average number of total born piglets and born alive piglets by sow
Feed Conversion Ratio (FCR) in each group of piglets
GTTT (technical results for sows in the farm)

Average Daily Weight gain is compared between groups using ANOVA test with 3 factors (group, parity of sow and farm) with sow as nested factor in group. The number of piglets per litter is used as covariate. Litter homogeneity is compared with calculation of standard deviation for each sow litter. ANOVA can be performed in case of normality or Mann-Whitney test elsewhere. The mortality is compared between groups with the Mantel-Haenszel test adjusted on farm or in case of low number by the Fisher exact test.

As shown in the table below, the gel feed reduces mortality rate and improves average daily gain in piglets.

mortality rate

| | Litters | Mortality rate | | |
|---|---|---|---|---|
| BREEDING | in the trial | Control | EARLYSTART | Gain (points) |
| CTPA Breeding | 35 | 14.6% | 7.5% | −7.1 |
| Cooperl Breeding N^{o} 1-Batch | 42 | 13.5% | 10.2% | −3.3 |
| N^{o} 1 | | | | |
| Cooperl Breeding N^{o} 1-Batch | 42 | 14.0% | 12.0% | −2 |
| N^{o} 2 | | | | |
| Cooperl Breeding N^{o} 2-Batch | 60 | 12.0% | 10.0% | −2 |
| N^{o} 1 | | | | |
| Cooperl Breeding N^{o} 2-Batch | 60 | 13.5% | 10.5% | −3 |
| N^{o} 2 | | | | |
| Cooperl Breeding N^{o} 3 | 30 | 14.2% | 8.5% | −5.7 |
| Breeding Japan N^{o} 1 | 20 | 14.2% | 7.6% | −6.6 |
| Results for mortality > 10% | 289 | 13.7% | 9.5% | −4.2 pts/−31% |
| Breeding University | 50 | 8.7% | 7.3% | −1.4 |
| Minnesota | | | | |
| Breeding Japan N^{o} 2 | 20 | 6.1% | 5.8% | −0.3 |
| Breeding Japan N^{o} 3 | 27 | 5.9% | 1.8% | −4.1 |
| Breeding South Korea N^{o} 1 | 44 | 8.5% | 4.3% | −4.2 |
| Breeding South Korea N^{o} 2 | 52 | 4.0% | 1.7% | −2.3 |
| Results for mortality < 10% | 193 | 6.6% | 4.2% | −2.4 pts/−37% |
| Average mortality rate | 482 | 10.8% | 7.3% | −3.5 |

Average Daily Gain

| | | | Piglet weight | Piglet weight | | |
|---|---|---|---|---|---|---|
| | Litters in | Weaning | at D 0 | at weaning | ADG | |
| BREEDING | the trial | (days) | (kg) | (kg) | (g) | Gain |
| CTPA | 65 | 21 | 100% | 100% | 100% | +28 g/20% |
| | | | 105% | 116% | 120% | |
| Cooperl | 42 | 28 | 100% | 100% | 100% | +16 g/7% |
| Breeding No1 | | | 104% | 106% | 107% | |
| Field trial, | 65 | 21 | 100% | 100% | 100% | +32 g/15% |
| Denmark | | | 99% | 111% | 115% | |
| Breeding | 44 | 21 | 100% | 100% | 100% | +8 g/4% |
| South Korea | | | 110% | 106% | 104% | |
| ADG | 186 | 21 or | 1.34 | 5.81 | 194 | +11% |
| | | 28 days | vs. 1.40 | vs. 6.34 | vs. 215 | |

The disclosures of each and every patent, patent application, or publication cited herein are hereby incorporated by reference in their entirety. While this invention has been disclosed with reference to specific embodiments, other embodiments and variations of this invention may be devised by others skilled in the art without departing from the true spirit and scope of the invention. The appended claims are intended to be construed to include all such embodiments and variations.

1. A process for preparing a gelled feed for an animal, comprising:
a) forming a mixture of water and a gelling agent, wherein the temperature of the water is from 60° C. to 85° C.,
b) adding one or more nutritive elements to the mixture,
c) cooling the mixture until it has gelled, and
d) destructuring the gelled mixture to obtain a gelled feed,
wherein the gelling agent comprises from 50 to 75% by weight of xanthan gum, from 0.5 to 13% by weight of locust bean gum, and from 12 to 37% by weight of guar gum, relative to the total weight of the gelling agent.

2. The process of claim 1, wherein the step of forming the mixture of water and the gelling agent is carried out at a temperature of about 60° C. to about 70° C.

3. The process of claim 1, wherein the step of forming the mixture of water and the gelling agent is carried out at a temperature of about 65° C. to about 85° C.

4. The process of claim 1, wherein the step of forming the mixture of water and the gelling agent is carried out at a temperature of about 80° C.

5. The process of claim 1, wherein the cooling is carried out until the mixture reaches a temperature of less than or equal to about 20° C.

6. The process of claim 1, wherein the mixing in step a) is carried out under high shear.

7. The process of claim 1, wherein step b) is carried out while mixing at a temperature of from 60° C. to 70° C.

8. A gelled feed composition for an animal, wherein the composition is formed by the process of claim 1.

9. The gelled feed of claim 8, comprising from 0.1 to 2% by weight of gelling agent relative to the weight of the gelled feed.

10. A gelling agent comprising from 50 to 75% by weight of xanthan gum, from 0.5 to 13% by weight of locust bean gum and from 12 to 37% by weight of guar gum, relative to the total weight of the gelling agent.

11. The gelling agent of claim 10, wherein the gelling agent is substantially free of pectin.

12. The gelled feed of claim 8, wherein the gelled feed is substantially free of pectin.

13. A method for feeding an animal, comprising providing to an animal a gelled feed formed according to the process of claim 1.

14. The method of claim 13, wherein the animal is swine.

15. The method of claim 13, wherein the gelled feed is provided within about the first ten days after the animal's birth.
